(19) United States
(12) Patent Application Publication
(10) Pub. No.: US 2007/0268603 A1
(43) Pub. Date: Nov. 22, 2007

(54) DENTAL MIRROR WITH REFLECTIVE COATING

(76) Inventor: Ian A. McCabe, Holland, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 11/749,449

(22) Filed: May 16, 2007

Related U.S. Application Data
(60) Provisional application No. 60/800,785, filed on May 16, 2006.

(51) Int. Cl. G02B 7/182; G02B 5/08

(52) U.S. Cl. 359/883

(57) ABSTRACT

A mirrored substrate suitable for use in a dental mirror includes a glass substrate and a ruthenium coating deposited on the glass substrate. The ruthenium coating may be established at a front or first surface of the glass substrate, or the ruthenium coating may be established at a rear or second surface of the glass substrate. The ruthenium coating may have a coating thickness of about 250 angstroms to about 650 angstroms.

### CROSS REFERENCE TO RELATED APPLICATION

The present application claims the benefit of U.S. provisional application, Ser. No. 60/800,785, filed May 16, 2006, which is hereby incorporated herein by reference in its entirety.

### FIELD OF THE INVENTION

The present invention relates to mirror reflectors and, more particularly, to a mirror reflector for dental and other oral applications.

### BACKGROUND OF THE INVENTION

Dental mirrors for use by a dentist or oral hygienist to assist in viewing inside a patient's mouth are well known. Typically, such dental mirrors are biologically inert, environmentally stable and durable, and must be capable of being autoclaved and/or sterilized. It is desired that such mirrors are highly reflective. Conventionally, rhodium is used to establish the reflective coating or layer at a glass substrate of such dental mirrors. Such rhodium reflective coatings typically provide a reflectivity of about 75 to 76 percent reflectivity of light incident thereon (as measured by SAE J964a). However, rhodium is an ever increasingly expensive commodity, and there is a need for a more economical coating that still meets the reflectivity requirements and durability requirements of dental mirrors.

Therefore, there is a need in the art for reflector for dental mirrors that overcome the shortcomings of the prior art.

### SUMMARY OF THE INVENTION

The present invention provides a dental mirror that has a mirror reflector coating of metallic ruthenium established on a surface of a mirror substrate, such as glass. The ruthenium reflector coating may be established or disposed or deposited (preferably by sputtering in a vacuum chamber) on either the outer or front or first surface of the substrate (the surface facing the person or dentist viewing the mirror) or, less preferably, the rear or second surface of the substrate (the surface at the rear of the substrate and at the opposite side of the glass substrate from the person viewing the mirror). The mirror preferably includes an adhesion promoting layer between the substrate surface and the ruthenium reflector coating and/or an adhesion promoting surface treatment or activation to enhance the adhesion of the ruthenium reflector coating to the substrate surface.

By coating the reflector substrate with ruthenium, cost reduction is achieved over conventional rhodium coated substrates. The ruthenium reflector coating provides sufficient reflectivity of light incident thereon (such as about 70 percent to about 73 percent reflective of light incident thereon) and is suitable for autoclaving/sterilizing, so that such a reflector coating is suitable for use in dental mirror applications.

These and other objects, advantages, purposes and features of the present invention will become apparent upon review of the following specification in conjunction with the drawings.

### BRIEF DESCRIPTION OF THE DRAWINGS

FIG. 1 is a perspective view of a dental mirror in accordance with the present invention;

FIG. 2 is a sectional view of the reflector portion of the dental mirror, with the reflector coating at the front surface of the mirror substrate;

FIG. 3 is a sectional view of the reflector portion of the dental mirror, with the reflector coating at the rear surface of the mirror substrate;

FIG. 4 is a sectional view of a reflective element of a dental mirror of the present invention;

FIG. 5 is a sectional view of another reflective element of a dental mirror of the present invention;

FIG. 6 is a schematic of the reflectance of a reflective element of the present invention;

FIG. 7 is a schematic of the reflectance of another reflective element of the present invention;

FIG. 8 is a schematic of the reflectance of another reflective element of the present invention;

FIG. 9 is a schematic depicting the reflectance versus viewing angle of a reflective element of the present invention;

FIG. 10 is a schematic depicting the reflectance versus wavelength achieved by an all dielectric mirror in accordance with the present invention;

FIG. 11 is a schematic depicting the reflectance versus viewing angle of the all dielectric mirror of the present invention; and

FIG. 12 is a sectional view of another mirror reflector in accordance with the present invention.

### DESCRIPTION OF THE PREFERRED EMBODIMENTS

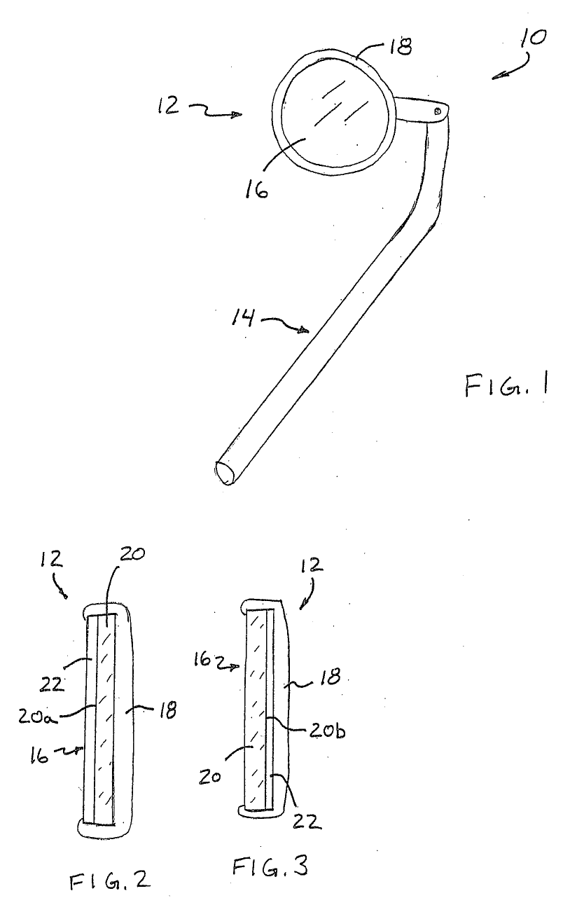

Referring now to the drawings and the illustrative embodiments depicted therein, a dental mirror 10 includes a reflector portion 12 adjustably or pivotably mounted to a handle portion 14 (FIG. 1). Reflector portion 12 includes a reflective element 16 disposed at or in a metal casing 18 and is adjustable relative to handle portion 14 to reflect light at a desired angle for viewing by the dentist or oral hygienist using the dental mirror. Reflective element 16 comprises a mirror substrate 20, such as glass, such as, for example, tempered glass, and a reflector coating 22 disposed at a surface of mirror substrate 20. Reflector coating 22 comprises a metallic ruthenium thin film coating, which may be sputter coated or sputter deposited onto a surface of mirror substrate 20 to establish a reflective layer or coating at the substrate. As shown in FIG. 2, reflector coating 22 may be disposed at a front or first surface 20a of mirror substrate 20 to establish a first surface reflector or alternately, and as shown in FIG. 3, reflector coating 22 may be disposed at a rear or second surface 20b of mirror substrate 20 to establish a second surface reflector. The metallic ruthenium thin film coating provides a specularly reflective, mirrored reflector coating that is substantially reflective of light incident thereon, as discussed below.

The ruthenium reflector coating 22 has surprisingly been found to provide sufficient reflectance and high performance and durability to the mirror reflector. Such a ruthenium reflector coating thus provides a reflector that provides high reflectivity of light incident thereon, while providing a reduced cost to the mirror reflector as compared to conventional mirror reflectors having a rhodium reflector coating. For example, the ruthenium coating has been found to provide a specular reflectivity of about 70 percent to about 73 percent reflectivity of light incident thereon (as measured by SAE J964a). Although slightly lower than the reflectivity typically achieved by rhodium (which is about 75-76 percent or thereabouts), the ruthenium coating provides sufficient reflectivity for its intended purpose. However, in order to achieve the desired or appropriate reflectance, the substrate and/or any adhesion layer (such as discussed below) and/or the ruthenium coating itself are preferably substantially smooth and not micro-rough.

Mirror substrate 20 of reflective element 16 may comprise any suitable substrate, such as a glass substrate or polycarbonate substrate or the like. Optionally, and desirably, the substrate comprises a thin glass substrate, such as a glass substrate having a thickness of about 1.1 mm or about 1.6 mm or thereabouts. However, other thicknesses (such as thicker or thinner glass) and other materials may be utilized without affecting the scope of the present invention.

The metallic ruthenium thin film coating may be substantially all ruthenium metal or may be a predominantly ruthenium metal alloy (with the total non-ruthenium constituents comprising preferably no more than 25 percent of the alloy composition, more preferably no more than 15 percent of the alloy composition, and more preferably no more than 10 percent of the alloy composition). The ruthenium coating or layer may be disposed at the surface of substrate 20 (and/or at or over an adhesion promoting layer or the like, such as discussed below), such as a layer having a physical thickness of about 250 angstroms to about 650 angstroms or thereabouts, and more preferably of about 350 angstroms to about 550 angstroms or thereabouts, and provides a highly reflective coating or layer for the mirror reflector. The physical thickness of the ruthenium reflector coating is selected to be sufficiently thick to provide the sufficient reflectivity and to provide a substantially smooth and not micro-rough layer.

The ruthenium reflector coating 22 may be disposed, such as by sputter coating or sputter deposition in a vacuum deposition chamber, such as is known in the coating arts, onto the substrate surface. For example, the ruthenium reflector coating may be disposed by sputter deposition, such as by using aspects of the sputter coating processes and chambers described in U.S. pat. applications, Ser. No. 11/226,628, filed Sep. 14, 2005 (Attorney Docket DON01 P-1236); and/or Ser. No. 11/021,065, filed Dec. 23, 2004 by McCabe et al. for ELECTRO-OPTIC MIRROR CELL (Attorney Docket DON01 P-1193); and/or PCT Application No. PCT/US2006/018567, filed May 15, 2006 by Donnelly Corp. et al. for VEHICLE MIRROR ASSEMBLY WITH INDICIA AT REFLECTIVE ELEMENT, and published Nov. 23, 2006 as International Publication No. WO 2006/124682 (Attorney Docket DON01 FP-1274(PCT)), which are hereby incorporated herein by reference in their entireties. The sputtering may be accomplished by direct current (DC) sputtering, or may be accomplished by pulsed DC sputtering, or by medium frequency (such as within a range of about 40 kHz to about 1 MHz or thereabouts) dual magnetron DC sputtering. Alternatively, radio frequency (RF) sputtering could be used or other sputtering techniques or systems may be used, depending on what is better suited for the particular chamber and chamber conditions.

Optionally, enhanced adhesion may be achieved by surface treatment and/or activation of the glass prior to deposition, such as by sputtering, of the ruthenium layer (and/or any underlying adhesion promoting layers). Such surface treatment may include plasma activation (such as by utilizing aspects of the processes described in U.S. patent application Ser. No. 11/021,065, filed Dec. 23, 2004 by McCabe et al. for ELECTRO-OPTIC MIRROR CELL (Attorney Docket DON01 P-1193), which is hereby incorporated herein by reference in its entirety), microwave activation, and/or radiation activation, such as ultraviolet (UV) activation or the like, and/or may be accompanied by heating the substrate to an elevated temperature, such as by heating the substrate to a temperature of about 80 degrees Celsius or more, more preferably to a temperature of about 120 degrees Celsius or more, and more preferably to a temperature of about 180 degrees Celsius or more. Preferably, an adhesion promoting layer is disposed to undercoat the ruthenium metallic reflecting layer so as to enhance its adhesion to the glass substrate. Optionally, the adhesion enhancing layer may comprise a metallic material, such as chromium or the like, or a metal oxide, such as silicon-oxide (SiO₂) or the like. Use of a metallic specularly reflecting metallic undercoating layer, such as chromium metal, is preferred, as such a metallic thin film coating can itself be specularly reflecting and thus can augment the reflectance off the overlying ruthenium thin film reflective layer. For example, and as shown in FIG. 3, an adhesion promoting layer or coating 24 may be disposed at the surface of substrate 20, and the ruthenium reflector coating 22 may be disposed or overcoated over the underlying adhesion promoting layer 24. The adhesion promoting layer 24 is disposed at the substrate surface at a desired thickness to provide the desired adhesion enhancement while being substantially smooth and not micro-rough. For example, the adhesion promoting layer may be disposed at the substrate surface at a thickness of about 150 angstroms to about 450 angstroms or thereabouts. The adhesion promoting layer thus enhances the adhesion of the overlaying ruthenium reflector coating to the mirror substrate, and may also contribute to the overall reflectivity level achieved by the dental mirror.

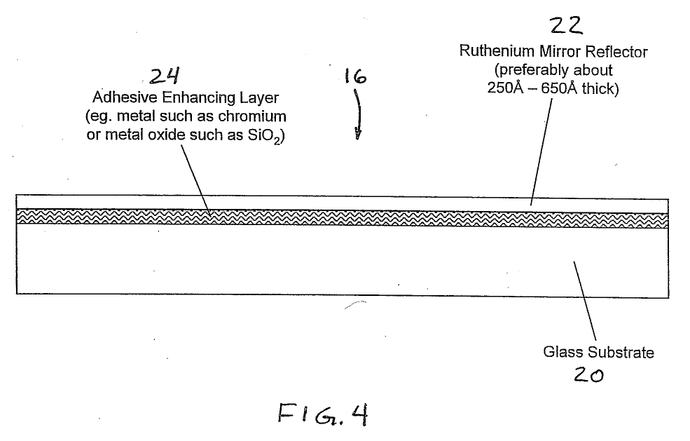

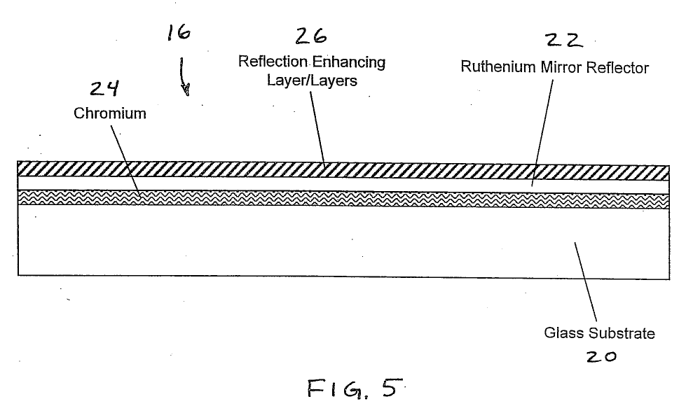

Optionally, and as shown in FIG. 4, an optical layer or reflection enhancing layer or layers 26 may be established at the surface of the mirror reflector, such as by overcoating the ruthenium reflector coating 22 and adhesion promoting layer 24 with layer/layers 26. The layer/layers 26 may comprise a metal oxide, such as silicon dioxide or the like, and may provide optical enhancement of the reflectivity of the ruthenium reflector coating to provide enhanced reflective performance of the dental mirror.

Examples of various interference effects of metal oxides or other similar or suitable optical or reflection enhancing or dielectric materials are described in U.S. Pat. Nos. 6,690,268; 5,668,663; 5,142,406; 5,442,478 and 5,724,187; and/or PCT Application No. PCT/US03/29776, filed Sep. 19, 2003 by Donnelly Corp. et al. for MIRROR REFLECTIVE ELEMENT ASSEMBLY, and published Apr. 1, 2004 as International Publication No. WO 2004/026633 (Attorney Docket DON01 FP-1109(PCT)); and/or PCT Application No. PCT/US03/35381, filed Nov. 5, 2003 by Donnelly Corp. et al. for ELECTRO-OPTIC REFLECTIVE ELEMENT ASSEMBLY, and published May 21, 2004 as International Publication No. WO 2004/042457 (Attorney Docket DON01 FP-1116(PCT)); PCT Application No. PCT/US2004/015424, filed May 18, 2004 by Donnelly Corp. et al. for MIRROR ASSEMBLY FOR VEHICLE, and published Dec. 2, 2004 as International Publication No. WO 2004/10377282 (Attorney Docket DON01 FP-1150(PCT)); and/or PCT Application No. PCT/US2006/018567, filed May 15, 2006 by Donnelly Corp. et al. for VEHICLE MIRROR ASSEMBLY WITH INDICIA AT REFLECTIVE ELEMENT, and published Nov. 23, 2006 as International Publication No. WO 2006/124682 (Attorney Docket DON01 FP-1274(PCT)); and/or U.S. pat. applications, Ser. No. 11/226,628, filed Sep. 14, 2005 (Attorney Docket DON01 P-1236); Ser. No. 10/528,269, filed Mar. 17, 2005 (Attorney Docket DON01 P-1109); Ser. No. 10/533,762, filed May 4, 2005, now U.S. Pat. No. 7,184,190 (Attorney Docket DON01 P-1116); Ser. No. 10/054,633, filed Jan. 22, 2002 by Lynam et al. for VEHICULAR LIGHTING SYSTEM, now U.S. Pat. No. 7,195,381 (Attorney Docket DON01 P-962); and/or Ser. No. 11/021,065, filed Dec. 23, 2004 by McCabe et al. for ELECTRO-OPTIC MIRROR CELL (Attorney Docket DON01 P-1193), which are hereby incorporated herein by reference in their entireties.

The ruthenium reflector coating may be disposed or deposited onto the surface of the substrate, such as onto the cut, typically round or circular mirror shapes (such as typically desired for a dental mirror), or the ruthenium reflector coating may be deposited onto larger sheets or substrates, where the ruthenium coated sheets or substrates are subsequently cut or formed into the typically round or circular mirror shapes. For example, large sheets of glass may be coated with ruthenium (and/or other coatings or layers as discussed above) and the coated sheets may be cut to form coated mirror shapes for use in the dental mirrors. Alternately, the sheets of glass (such as a clean or bare sheet of glass or a glass sheet including one or more layers or coatings other than the ruthenium coating, such as layers of the types discussed above) may be cut into mirror shapes and the mirror shapes may then be coated with the ruthenium reflector coating (and any other desired or appropriate coatings or layers as discussed above).

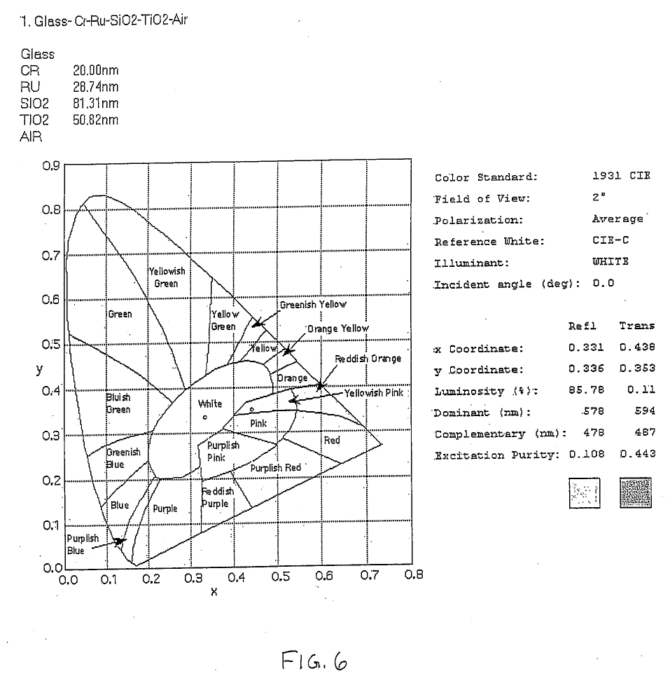

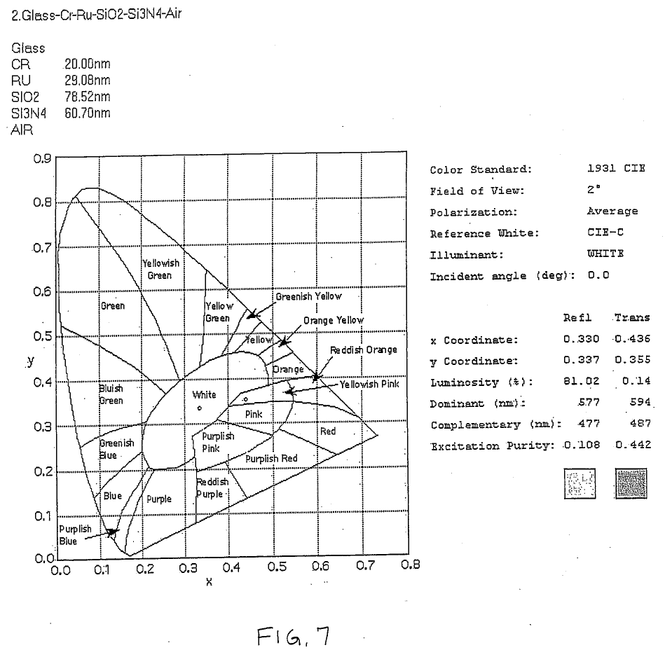

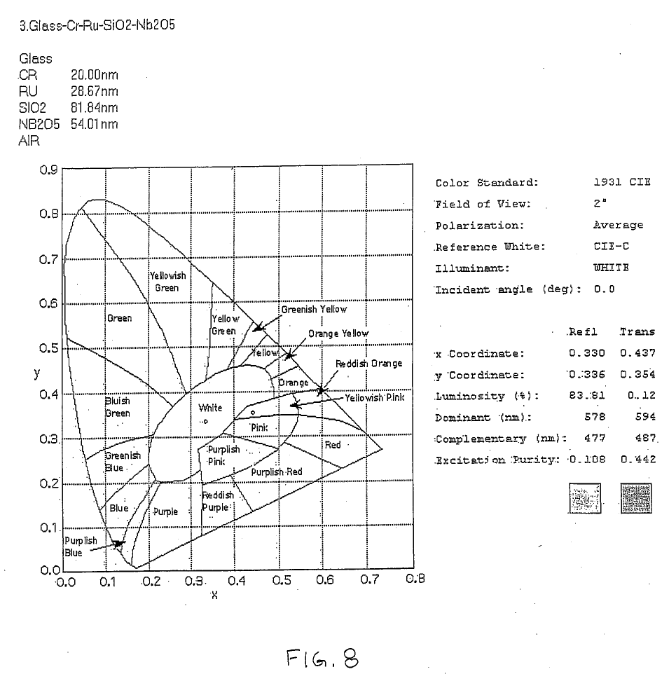

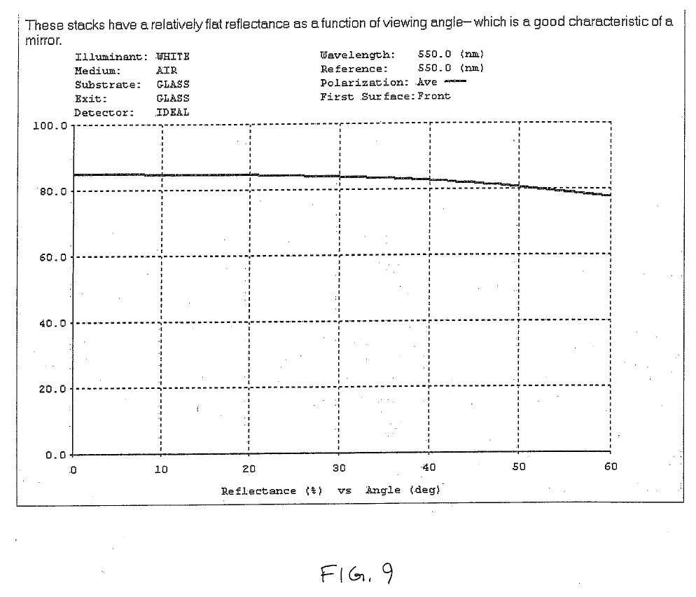

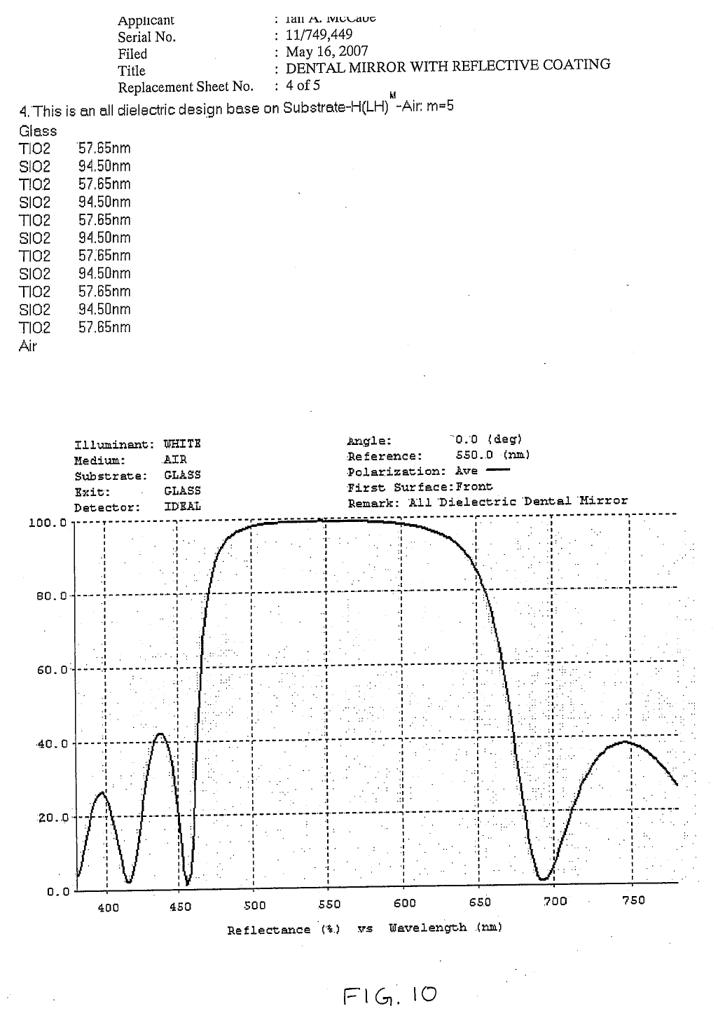

Enhanced reflectivity dental mirrors can be formed in accordance with the present invention by using a substrate-metal-(L-H)^{m}-air optical stack, where L represents a layer having a lower refractive index optical layer than another layer (a higher refractive index layer) designated as H (with m being typically from about 1 to 7 or thereabouts, and representing the multiplicity of the lower refractive index layer and higher refractive index layer sets or twins), and where air is the instant medium used for viewing the reflector. For example, a dental mirror with luminous reflectivity of about 86 percent, such as shown in FIG. 6, may be formed from glass coated with a layer of chromium (such as about 20 nm thick layer), a layer of ruthenium (such as about 29 nm thick), a layer of silicon oxide (such as about 81 nm thick) and a layer of titanium oxide (such as about 51 nm thick). Also, and for example, a dental mirror with luminous reflectivity of about 81 percent, such as shown in FIG. 7, may be formed from glass coated with a layer of chromium (such as about 20 nm thick layer), a layer of ruthenium (such as about 29 nm thick), a layer of silicon oxide (such as about 78.5 nm thick) and a layer of silicon nitride (such as about 61 nm thick). Also, and for example, a dental mirror with luminous reflectivity of about 84 percent, such as shown in FIG. 8, may be formed from glass coated with a layer of chromium (such as about 20 nm thick layer), a layer of ruthenium (such as about 29 nm thick), a layer of silicon oxide (such as about 82 nm thick) and a layer of niobium oxide (such as about 54 nm thick). Such stacks of layers or coatings of such designs have a relatively flat reflectance (such as greater than 80 percent as shown in FIG. 9) as a function of viewing angle, and preferably are silvery in reflectance so as to be substantially non-spectrally selective. Other thicknesses and layers may be implemented while remaining within the spirit and scope of the present invention.

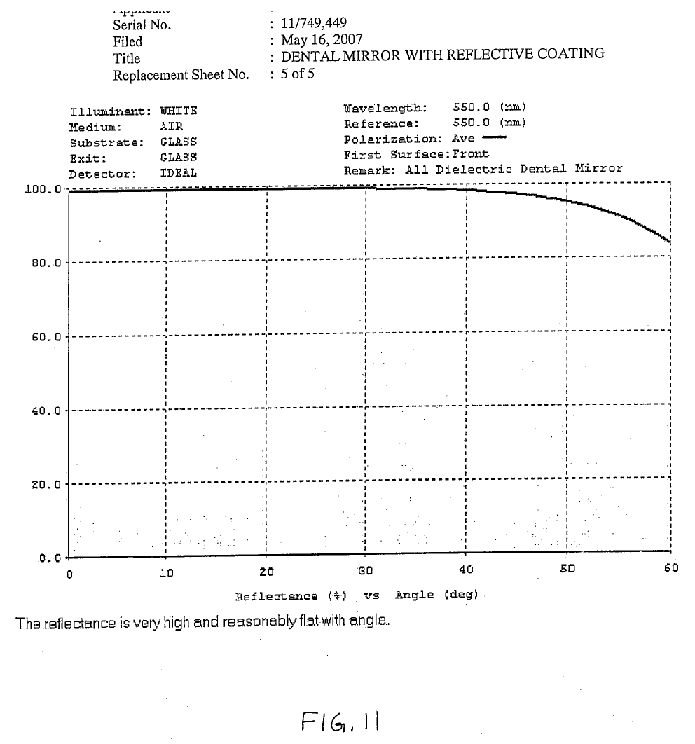

Should even higher reflectivity for a dental mirror, an all dielectric coated dental mirror that utilizes no metallic reflecting layer can be formed. Such a stack provides a high reflectivity of greater than about 90 percent reflectivity of light incident thereon, such as shown in FIGS. 10 and 11. For example, an all dielectric design may have a glass-H(LH)^{m} construction. For example, the construction may include a glass substrate coated with a layer of titanium oxide (such as about 58 nm thick) and alternating layers of silicon oxide and titanium oxide (such as the five (where m=5) alternating layers of silicon oxide and titanium oxide in the illustrated embodiment). As shown in FIG. 10, the alternating layers of silicon oxide and titanium oxide may comprise a layer of silicon oxide (such as about 94.5 nm thick), a layer of titanium oxide (such as about 58 nm thick), a layer of silicon oxide (such as about 94.5 nm thick), a layer of titanium oxide (such as about 58 nm thick), a layer of silicon oxide (such as about 94.5 nm thick), a layer of titanium oxide (such as about 58 nm thick), a layer of silicon oxide (such as about 94.5 nm thick), a layer of titanium oxide (such as about 58 nm thick), a layer of silicon oxide (such as about 94.5 nm thick), and a layer of titanium oxide (such as about 58 nm thick). Other thicknesses and layers may be implemented while remaining within the spirit and scope of the present invention. As can be seen in FIG. 11, the reflectance off of the all dielectric mirror is very high (such as greater than about 95 percent) and substantially flat or constant over a relatively large viewing angle.

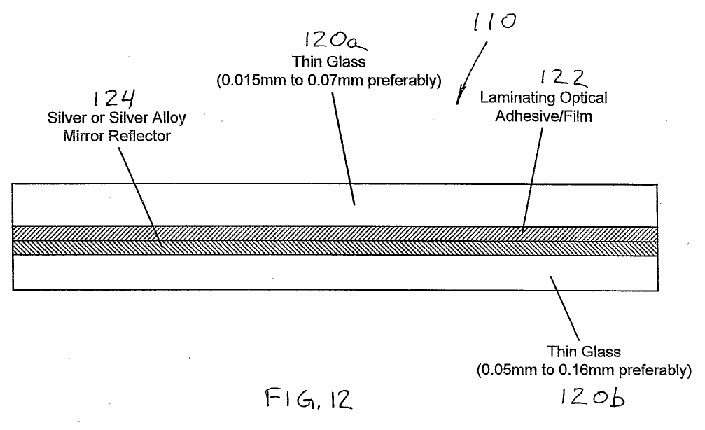

Optionally, and with reference to FIG. 12, a reflective element 110 for a dental mirror may comprise a laminated reflective element with a metallic reflector coating or layer or layers disposed or sandwiched between a pair of thin glass substrates. In the illustrated embodiment, the reflective element 110 includes a first thin glass substrate 120a (such as a glass substrate having a thickness of about 0.015 mm to about 0.07 mm or thereabouts) and a second thin glass substrate 120b (such as a glass substrate having a thickness of about 0.005 mm to about 0.16 mm or thereabouts), with a laminating optical adhesive or film 122 (such as the types described in U.S. pat. application, Ser. No. 10/993,302, filed Nov. 19, 2004 (Attorney Docket DON01 P-1186); and/or PCT Application No. PCT/US2006/018567, filed May 15, 2006 by Donnelly Corp. et al. for VEHICLE MIRROR ASSEMBLY WITH INDICIA AT REFLECTIVE ELEMENT, and published Nov. 23, 2006 as International Publication No. WO 2006/124682 (Attorney Docket DON01 FP-1274(PCT)), which are hereby incorporated herein by reference in their entireties) and a silver or silver alloy metallic layer mirror reflector 124 sandwiched therebetween. The mirror reflector thus provides a highly reflective (such as greater than about 85 percent reflectivity of light incident thereon) mirror reflector, with the metallic reflective layer being substantially protected between the glass substrates. The metallic reflective layer preferably comprise a silver or silver alloy, such as, for example, a silver-palladium alloy or other silver alloys, and may include or comprise other materials or metals or metal alloys, such as a ruthenium alloy or a platinum or palladium metal or alloy or the like.

Therefore, the present invention provides a dental mirror with a reflector coating comprising ruthenium, which provides high reflectivity of light incident thereon, while meeting the durability requirements of such dental mirrors. Although ruthenium is slightly less reflective than rhodium, the reflectivity of ruthenium is sufficient for dental mirror applications. Further, the ruthenium reflector coating is durable and thus is suitable for steam autoclaving (such as at about 121 degrees Celsius or more and at about 15 to 80 p.s.i. steam) and sterilizing. Thus, the ruthenium coated mirror reflector for dental mirrors of the present invention provides high reflectivity and high durability to the dental mirror, and typically provides a substantial reduction in cost of such dental mirrors due to the lower cost of ruthenium sputter targets as compared to rhodium sputter targets.

Note that ruthenium may be alloyed or mixed with other metals, so as to enhance a physical property of the dental mirror (such as to enhance reflectivity if alloyed with rhodium), or to reduce the cost of the dental mirror (such as if alloyed or mixed with palladium or platinum). Desirably, such an alloyed composition comprises at least about 85 percent ruthenium, and more preferably at least about 90 percent ruthenium. Optionally, a dental mirror can be formed from palladium or platinum or palladium alloy (such as palladium alloyed with platinum or rhodium or ruthenium), or a platinum alloy (such as platinum alloyed with palladium or rhodium or ruthenium). For economy, the dental mirror may be formed with a glass substrate coated with a platinum or platinum alloy reflector coating, or the dental mirror may be formed with a glass substrate coated with a palladium or palladium alloy reflector coating. However, use of a ruthenium coating is preferred because of its superior reflectivity characteristics.

Changes and modifications to the specifically described embodiments may be carried out without departing from the principles of the present invention, which is intended to be limited only by the scope of the appended claims as interpreted according to the principles of patent law.

The embodiments of the invention in which an exclusive property or privilege is claimed are defined as follows:

1. A mirrored substrate suitable for use in a dental mirror, said mirrored substrate comprising a glass substrate and a ruthenium coating deposited on said glass substrate.

2. The mirrored substrate of claim 1, wherein said ruthenium coating is established at a front or first surface of said glass substrate.

3. The mirrored substrate of claim 1, wherein said ruthenium coating is established at a rear or second surface of said glass substrate.

4. The mirrored substrate of claim 1, wherein said ruthenium coating has a coating thickness of about 250 angstroms to about 650 angstroms.

5. The mirrored substrate of claim 1, wherein said ruthenium coating has a coating thickness of about 350 angstroms to about 550 angstroms.

6. The mirrored substrate of claim 1, wherein said mirrored substrate includes an adhesion enhancing layer disposed at said surface of said glass substrate and between said ruthenium coating and said surface of said glass substrate.

7. The mirrored substrate of claim 6, wherein said adhesion enhancing layer has a layer thickness of about 150 angstroms to about 450 angstroms.

8. The mirrored substrate of claim. 6, wherein said mirrored substrate includes an optical layer overcoated over said ruthenium coating.

9. The mirrored substrate of claim 8, wherein said optical layer comprises a reflection enhancing layer.

10. The mirror substrate of claim 1, wherein said mirrored substrate has a specular reflectivity of at least about 70 percent reflectivity of light incident thereon as measured by SAE J964a.

11. A mirrored substrate suitable for use in a dental mirror, said mirrored substrate comprising a glass substrate and a ruthenium coating deposited on said glass substrate, wherein said ruthenium coating is established at a front or first surface of said glass substrate, said ruthenium coating having a coating thickness of greater than about 250 angstroms.

12. The mirrored substrate of claim 11, wherein said ruthenium coating is established at a rear surface of said glass substrate.

13. The mirrored substrate of claim 11, wherein said mirrored substrate includes an adhesion enhancing layer disposed at said surface of said glass substrate and between said ruthenium coating and said surface of said glass substrate.

14. The mirrored substrate of claim 13, wherein said adhesion enhancing layer has a layer thickness of about 150 angstroms to about 450 angstroms.

15. The mirrored substrate of claim 13, wherein said mirrored substrate includes an optical layer overcoated over said ruthenium coating.

16. The mirrored substrate of claim 15, wherein said optical layer comprises a reflection enhancing layer.

17. The mirror substrate of claim 11, wherein said mirrored substrate has a specular reflectivity of at least about 70 percent reflectivity of light incident thereon as measured by SAE J964a.
